(19) United States
(12) Patent Application Publication
(10) Pub. No.: US 2007/0017114 A1
(43) Pub. Date: Jan. 25, 2007

(54) Wearable hair styling device and method

(76) Inventors: Carol Perrin, Los Angeles, CA (US); Michael J. O'Rourke, Topanga, CA (US)

Correspondence Address: GREENBERG TRAURIG LLP, 2450 COLORADO AVENUE, SUITE 400E, SANTA MONICA, CA, 90404, US

(21) Appl. No.: 11/190,160

(22) Filed: Jul. 25, 2005

(51) Int. Cl. F26B 19/00; A45D 1/00

(52) U.S. Cl. 34/90; 34/96

(57) ABSTRACT

A wearable hair styling device in a case, attachable to a user. A hose connect on the case to affix a hose. A battery power supply connected to an electric motor and blower and heater are used to direct air through a hose.

### BACKGROUND OF THE INVENTION

1. Field of the Invention

This present invention relates to a hair drying and styling. More specifically, to a wearable device and method separating the heavy battery, motor and blower from the air dispensing end for hair styling and/or drying.

2. Related Art

A variety of wearable hair styling and drying devices are known in the art. See generally U.S. Pat. Nos. 6,052,915, 6,038,783, 3,377,715 and U.S. patent application 2003/0163930.

A hand held hair dryer is a device used to dry hair. Such devices contain a motor, a fan, a blower end and in some cases a battery. The weight of such device can vary from many ounces to many pounds depending on the device. Persons who use such devices must support the weight of the device with their hand, wrist, arm, shoulder and/or back during usage. For styling professionals such periods of use may be hours per day. The weight of the device can cause fatigue and place stress on the arm and wrist of the user.

It would therefore be a desideratum to have a styling and drying device that eliminated a portion of the weight of the device from at least one of the hand, wrist, arm, shoulder and/or back of the hand, wrist and/or arm of the user.

### SUMMARY OF THE INVENTION

The present invention is a wearable hair styling device which can reduce at least a portion of the weight of the device by separating the blower end from the other parts of the device.

In some exemplary implementations the device can be a plug in device which mates with a wall socket, or contain a battery supply.

In some exemplary implementations the battery for the device may be rechargeable and/or replaceable.

In some exemplary implementations the device can use detachable styling attachments.

In some exemplary implementations a portion of the device is be attached to a waist belt.

In some exemplary implementations a portion of the device is be attached to a arm belt.

In some exemplary implementations the device is attached to an over the shoulder strap or harness.

A method of styling and/or drying hair by separating the blower and heater portion of a hair styling device on a wearable fixture such as a belt, strap, clip or other attachment and passing the air from the blower and/or heater through a hose.

A wearable hair styling unit in a case, attachable to a user. A hose connect on the case to affix a hose. An electric motor within the case and a blower connected to the electric motor whereby air is directed to the hose connect. Heater element(s) may be added.

A wearable hair styling unit in a case, attachable to a user. A hose connect on the case to affix a hose. An electric motor within the case and a blower connected to the electric motor whereby air is directed to the hose connect. A hose and nozzle connect to the free end of the hose. A handle may be added. Heater element(s) may be added.

A rechargeable battery power supply may be added, or the unit may have a plug in for wall socket use. When utilizing a rechargeable power supply a recharging stand is combined to charge either the unit or the battery power supply within the unit. Removing the battery power supply in the unit and swapping it with a second charged battery power supply can allow for prolonged use.

Other features and advantages of the present invention will be set forth, in part, in the descriptions which follow and the accompanying drawings, wherein preferred embodiments and some exemplary implementations of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations of elements and instrumentalities particularly pointed out in the appended claims.

### BRIEF DESCRIPTION OF THE DRAWINGS

FIG. 1A is a component diagram of an implementation of the device.

FIG. 1B is side view of the implementation of FIG. 1A.

FIG. 1C is another side view of the implementation of FIG. 1A.

FIG. 1D is a side view of another implementation of FIG. 1A.

FIG. 2 is a component diagram of another implementation of the device.

FIG. 3 is a component diagram of another implementation of the device.

FIG. 4 is a waist belt implementation of the device.

FIG. 5 is an arm belt implementation of the device.

FIG. 6 is a shoulder harness implementation of the device.

FIG. 7 is a back harness implementation of the device.

FIG. 8 is a styling attachment for the device.

FIG. 9 is another styling attachment for the device.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DESCRIPTION OF THE PREFERRED EMBODIMENTS OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure.

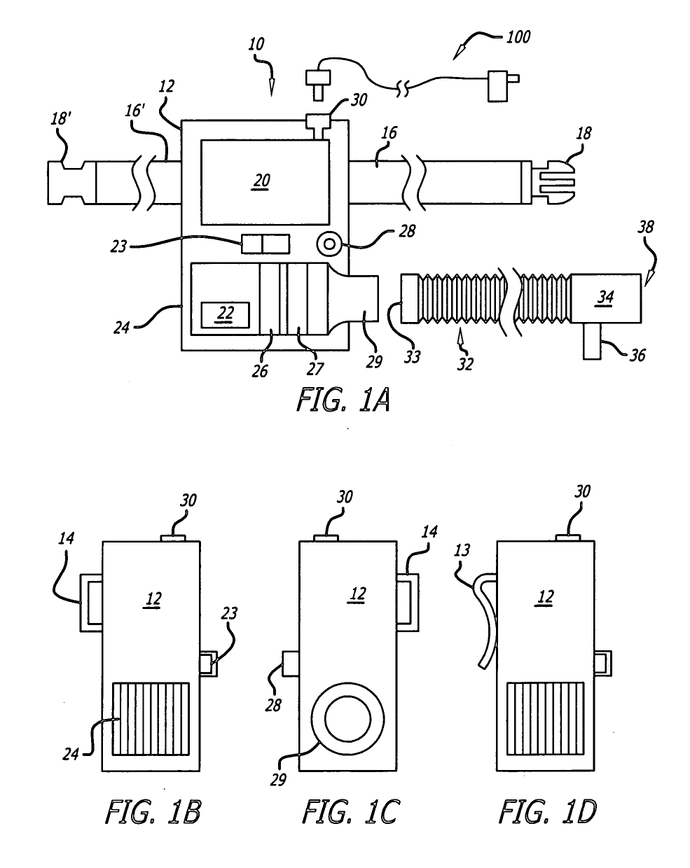

Shown in FIGS. 1A, 1B, 1C, 2 and 3 are a hair styling and drying devices. FIGS. 1A-1D show a device 10 housed in a case 12 with a strap guide 14 formed or affixed thereon. The strap guide 14 may also be formed as a clip 15 for clipping the device 10 onto a strap, belt, clothing or other worn article. A strap 16 with connectable latch and catch 18 & 18′ on either end to which the hair styling and drying device 10. A rechargeable battery supply 20 is within the case 12. A motor 22 receives power from the battery supply 20. An electric motor 22 switchably connected to the battery supply 20 by an on/off switch 23. The on/off switch may be a variable switch which controls the motor speed, or it may be a multi-level switch providing for on, off and/or low, medium and high settings. A vent 24 on the case provides a pathway for air flow to the electric motor 22 which drives the blower fan 26 that generates an airflow which passes a heating element 27. The motor blower may be multiple connected part or a single element. When the heating element 27 is switched on, it may be switched to pre-selected levels or variable levels of heat. A heat control switch 28 is used to control the heat levels. The air flowing from the blower fan 26 passes from the case 12 through a hose connect 29. Although the hose connect 29 is shown extending from the case 12, those skilled in the art will recognize that an inverted, or female, hose connect which is substantially internal to the case 12 is also within this disclosure. The device 10 is rechargeable and the battery supply therein 12 is connectable to a recharging external plug and cable 100 via a plug-in jack 30. A connectable flexible hose 32 mates at its connecting end 33 to the hose connect 29. Air flows through the flexible hose 32 to the air director 34 which has a handle 36 and a nozzle 38.

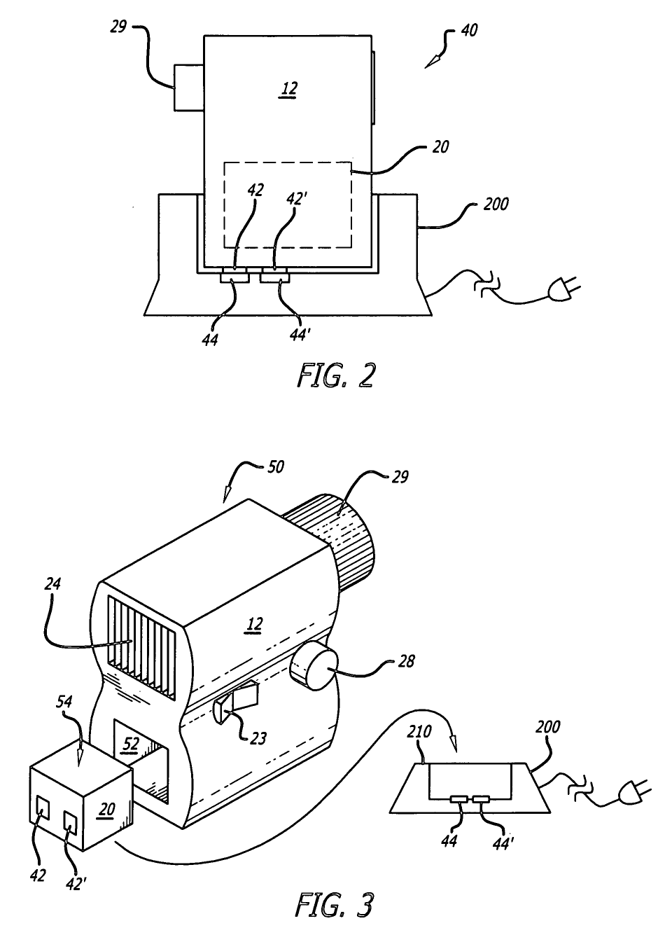

Shown in FIG. 2 is another implementation of the hair styling and drying device 40. The battery supply 20 within the case 12 is rechargeable via contact 42 and 42′ on, beyond, in or through the case 12 which correspond to contacts 44 & 44′ on the recharging stand 200. The recharging stand 200 is a dock which holds the device 40 and can also provide for recharging of the battery supply 20 within the device 40.

Shown in FIG. 3 is another implementation of the hair styling and drying device 50. The battery supply 20 is removable from the case. The battery supply 20 once removed is rechargeable via contact 42 and 42′ on, beyond, in or through the battery supply 20 which correspond to contacts 44 & 44′ on the recharging stand 210. The battery supply 20 mates with the device 50 via a receiving chamber 52.

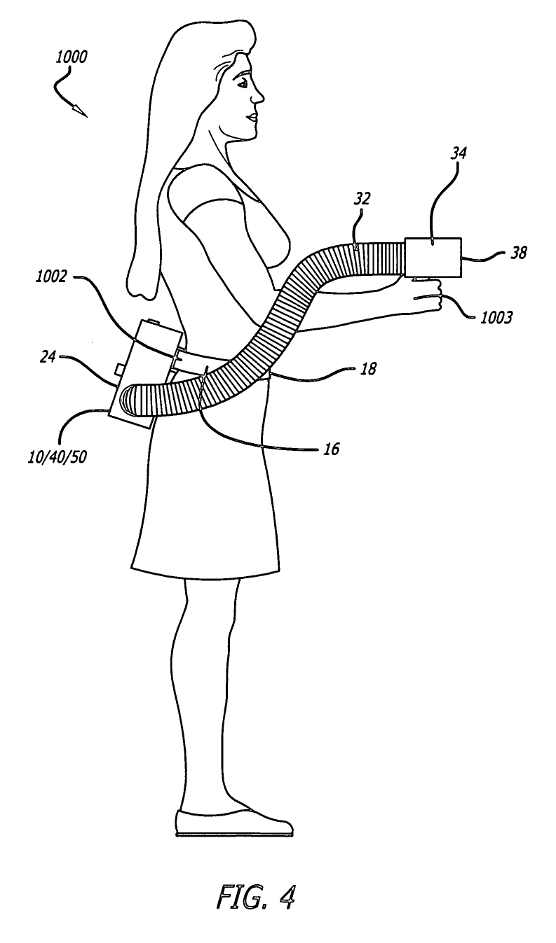

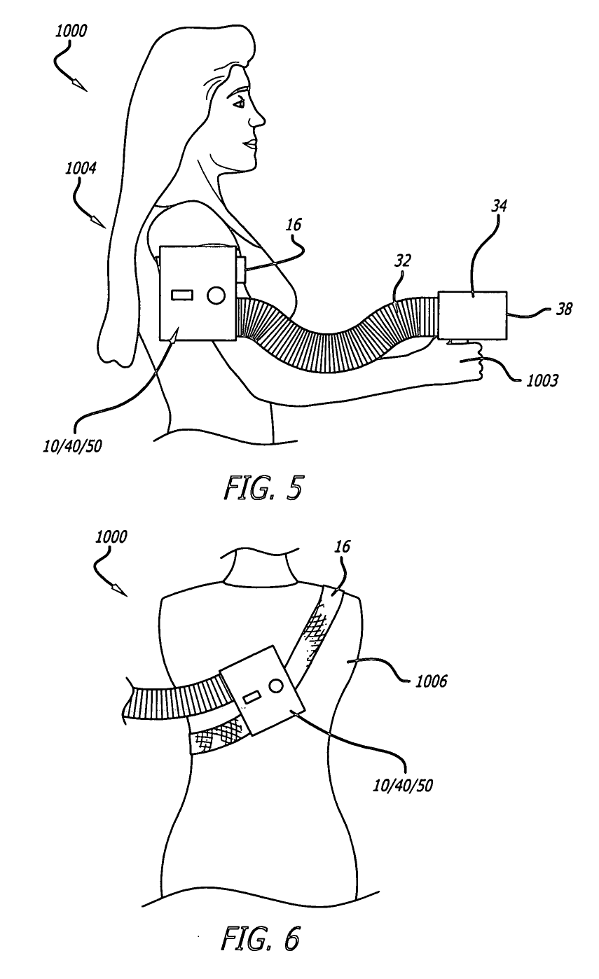

Shown in FIGS. 4-7 are implementations illustrating attaching the device 10/20/50 to a user. The devices 10/40/50 may be strapped on to user 1000 with a strap 16 and connectable latch and catch 18 & 18′. Shown in FIG. 4 the device 10/40/50 is strapped around her waist 1002 for use. The hair styling device may also be affixed with a strap 16 or belt to the user's 1000 arm 1004 as shown in FIGS. 5, or across a user's 1000 shoulder and back 1006 as shown in FIG. 6. The user 1000 uses her hand 1003 to hold the handle 36 and thereby direct the airflow via the nozzle 38. The flexible hose 32 can move as the nozzle 38 is directed.

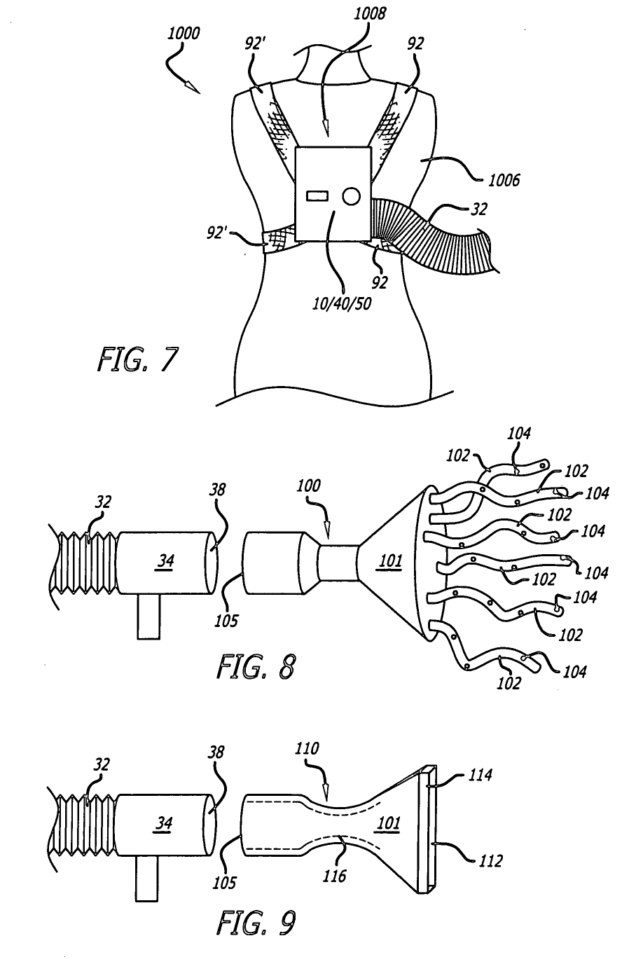

A double set of long straps 92 & 92′ are shown in FIG. 7 whereby the device 10/40/50 is mounted on a user's 1000 back 1008. Long straps 92 & 92′ connect the device in a back pack fashion over the shoulders.

Shown in FIGS. 8 and 9 are styling attachments. In FIG. 8 is an octopus attachment 100 to fit over the end of a nozzle 98. Although shown attached to nozzle 38 of the wearable device, this illustration is not a limitation and the octopus attachment may be used with any air blowing nozzle including those on traditional hair dryers.

The Octopus body 101 supports the tentacles 102, on the tentacles may be vent holes 104 through which the air flow from the nozzle 38 is directed. The octopus 100 connect to the nozzle 38 at the connection head 105 in a slide, pressure, screw, snap or other connection to place the octopus on the nozzle.

Shown in FIG. 9 is a slit styler 110. The slit styler 110 is a narrow passageway 112 supported in a slit body 114 whereby the flow channel 116 narrows to a slit 112 and the air flows out of the slit 112. The slit styler 110 connects to the nozzle 38 at the connection head 105 in a slide, pressure, screw, snap or other connection to place the slit styler 110 on the nozzle.

Since certain changes may be made in the above apparatus without departing from the scope of the invention herein involved, it is intended that all matter contained in the above description, as shown in the accompanying drawing, shall be interpreted in an illustrative, and not a limiting sense.

I claim:

1. A wearable hair styling DEVICE comprising:
A case with hose connect;
A rechargeable battery supply in the case;
A means to attach the case to a user;
An electric motor within the case;
A blower connected to the electric motor whereby air is directed out the hose connect;
A switch means connecting the battery power supply to the motor blower.

2. The wearable hair styling device of claim 1 further comprising a heater element in the case whereby the air directed out the nozzle may be heated prior to leaving the case.

3. The wearable hair styling device of claim 1 further comprising a hose attached to the hose connect with a free end.

4. The wearable hair styling device of claim 3 further comprising a nozzle attached to the free end of the hose.

5. The wearable hair styling device of claim 3 further comprising a handle and nozzle attached to the free end of the hose.

6. The wearable hair styling device of claim 1 wherein the means to attach the case is selected from the group consisting of: strap, clip, harness, belt; shoulder strap and belt.

7. The wearable hair styling device of claim 3 further comprising a styling attachment connected to the nozzle.

8. The wearable hair styling device of claim 4 further comprising a styling attachment connected to the nozzle.

9. The wearable hair styling device of claim 1 wherein the case fits into a charging stand, whereby the battery supply is recharged.

10. The wearable hair styling device of claim 1 wherein the battery supply is removable.

11. The wearable hair styling device of claim 2 further comprising a heat control switch, whereby the temperature of the air exiting the device is adjusted by altering the amount of power supplied to the heater element.

12. A rechargeable wearable hair styling system comprising:
A case with hose connect;
A rechargeable battery supply in the case;
A means to attach the case to a user;
An electric motor within the case;
A blower connected to the electric motor whereby air is directed out the hose connect;
A switch means connecting the battery power supply to the motor blower; and,
A charging stand of a size and shape to receive the case and charge the battery power supply.

13. The wearable hair styling system of claim 11 further comprising a heater element in the case whereby the air directed out the nozzle may be heated prior to leaving the case.

14. The wearable hair styling system of claim 12 further comprising a heat control switch, whereby the temperature of the air exiting the case is adjusted by altering the amount of power supplied to the heater element.

15. The wearable hair styling system of claim 11 further comprising a hose attached to the hose connect with a free end.

16. The wearable hair styling system of claim 14 further comprising a nozzle attached to the free end of the hose.

17. The wearable hair styling system of claim 14 further comprising a handle and nozzle attached to the free end of the hose.

18. The wearable hair styling system of claim 11 wherein the means to attach the case is selected from the group consisting of: strap, clip, harness, belt; shoulder strap and belt.

19. The wearable hair styling system of claim 15 further comprising a styling attachment connected to the nozzle.

20. The wearable hair styling system of claim 16 further comprising a styling attachment connected to the nozzle.
